(19) United States
(12) Patent Application Publication
(10) Pub. No.: US 2006/0026301 A1
(43) Pub. Date: Feb. 2, 2006

(54) SNMP proxy agent

(75) Inventors: Hideki Maeda, Kawasaki (JP); Makoto Kobata, Kawasaki (JP); Satoshi Kumano, Kawasaki (JP); Kiyofumi Hara, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/197,258

(22) Filed: Aug. 5, 2005

Related U.S. Application Data
(63) Continuation of application No. PCT/JP03/01230, filed on Feb. 6, 2003.

(51) Int. Cl. G06F 15/16; G06F 15/173

(52) U.S. Cl. 709/246; 709/224

(57) ABSTRACT

An SNMP proxy agent includes a format conversion unit for converting management information received from a monitored device not using the SNMP as a management protocol, into a format corresponding to the SNMP, an IP address conversion unit for converting the particular information on the monitored device included in the management information into a virtual IP address indicating the monitored device, a trap generation unit for generating an SNMP trap having the virtual IP address set as a transmission origin and containing the management information after the conversion, and a transmission unit for transmitting the generated SNMP trap to an SNMP manager.

### CROSS-REFERENCE TO RELATED APPLICATION

This is a continuation of Application PCT/JP2003/001230, filed on Feb. 6, 2003, now pending, the contents of which are herein wholly incorporated by reference.

### BACKGROUND OF THE INVENTION

1. Field of the Invention

The present invention relates to a manager/agent model system having a manager/agent structure such as the SNMP (Simple Network Management Protocol). The present invention more particularly relates to an SNMP proxy agent which, in order to manage a monitored device which does not employ the SNMP as a monitoring protocol, converts the monitoring protocol of the monitored device into the SNMP.

2. Description of the Related Art

There have conventionally been various network management systems which are constructed by multiple network element devices (monitored devices such as transmission devices), networks (systems to be managed) which include transmission lines (paths) used to connect these network element devices with one other, and a monitoring device (management station) which monitors the networks to collect management information.

For example, when multiple SNMP incompliant transmission devices (agents), which do not have an IP (Internet Protocol) address, are to be monitored according to the SNMP, there is a manager/agent model system as a network management system which provides an SNMP proxy agent between the agents and a manager.

When a conventional SNMP proxy agent converts management information such as failure information and device status information transmitted from a monitored device which does not employ the SNMP as a management protocol thereof into information in the MIB (Management Information Base) format, and notifies an SNMP manager of the converted information, the SNMP proxy agent sets an IP address of the SNMP proxy agent to a sender address. As a result, in order to identify the monitored device, which is the sender of the management information, the SNMP manager uses a local address (a device name, a device number, or the like other than an IP address according to the present invention) of the monitored device as index information of the MIB, and thus identifies the device by means of the local address existing in various formats. In contrast, as disclosed in “JP 3017089 B: NETWORK MANAGEMENT DEVICE AND METHOD (Patent Document 1)”, there is provided such a device that an SNMP manager converts a local address of a monitored device into a virtual IP address, and the virtual IP address is newly set to the sender address within the SNMP manager, thereby carrying out identification in the unified format, for example. Moreover, as disclosed in “JP 2000-236348 A: MANAGEMENT SYSTEM FOR REMOTE DEVICE USING INTERNET PROTOCOL (Patent Document 2)”, there is employed such a configuration that a virtual address is provided to a proxy agent, and a socket to which the IP address is virtually assigned is used as a sender to communicate with a manager.

As described above, since a local address of a monitored device is conventionally used as an index, the information used to identify the device exists also in a format other than an IP address, and the management methods for the SNMP manager are not unified, resulting in a problem of complexity of the management and operation of the SNMP manager. To address this problem, according to a method for converting a local address to an IP address in an SNMP manager as disclosed in “JP 3017089 B (Patent Document 1)”, although the management can be carried out uniformly in the format of the IP address, since it is necessary to manage the local address of the monitored device within the SNMP manager, if a non-SNMP device to be newly supported is added, it is necessary to modify the address converting unit in addition to the SNMP proxy agent. In short, since it is necessary to modify the SNMP manager which is a manager of the system, the modification becomes complex and time consuming. On the other hand, according to a method which uses a socket to which an IP address is virtually assigned as described in “JP 2000-236348 A (Patent Document 2)”, there is a problem in that if there is added a non-SNMP device to be newly supported, it is necessary to change the IP address setting in the proxy agent (to add a socket), it is thus essential to modify the system at an OS level, and if the number of non-SNMP devices continues to increase, the communication capability of the overall system decreases, resulting in a possible exhaustion of system resource.
[Patent Document 1] JP 3017089 B
[Patent Document 2] JP 2000-236348 A

### SUMMARY OF THE INVENTION

The present invention is devised to solve the above problems. That is, one of objects of the present invention is to provide an SNMP proxy agent which can unify management methods for an SNMP manager, and simplify management and operation thereof.

Another object of the present invention is to provide an SNMP proxy agent which does not require a modification relating to the IP address management carried out by the SNMP agent even if a non-SNMP device to be newly supported is added.

In order to solve the above problems, the present invention adopts the following means. That is, the present invention is an SNMP proxy agent. The SNMP proxy agent includes a unit converting specific information (identifier) of a monitored device which does not employ an SNMP as a management protocol into a virtual IP address indicative of the monitored device; and a unit generating an SNMP trap message in which the virtual IP address is set to a source address, and which is addressed to an SNMP manager.

In the present invention, the SNMP proxy agent includes a format converting unit converting management information received from a monitored device which does not employ the SNMP as a management protocol into management information having a format according to the SNMP; an IP address converting unit converting specific information on the monitored device contained in the management information into a virtual IP address indicative of the monitored device; a trap generation unit generating an SNMP trap message in which the virtual IP address is set to a source address, and which contains the converted management information; and a transmission unit transmitting the generated SNMP trap message to an SNMP manager.

According to this configuration, upon identifying the management information received from the monitored device which does not employ the SNMP as the management protocol and the monitored device which is the sender (transmission source) of the management information, the SNMP manager can carry out management by means of the IP address as a unified format.

Preferably, if the trap generating unit receives management information from a monitored device employing the SNMP as a management protocol, the trap generating unit may generate a trap in which an IP address actually allocated to the monitored device is set to a source address.

According to this configuration, the SNMP manager can manage the management information received from the monitored device which employs the SNMP as the management protocol in a similar manner to that of the monitored device which does not employ the SNMP as the management protocol.

Preferably, if a version of the SNMP corresponding to the monitored device is a version 1, the trap generating unit may set the virtual IP address as control information to an agent address section in a trap format of the SNMP version 1.

Preferably, if a version of the SNMP corresponding to the monitored device is a version 2, the trap generating unit may set the virtual IP address as control information to a data main body section in a trap format of the SNMP version 2 as an object.

Preferably, if a version of the SNMP corresponding to the monitored device is a version 3, the trap generating unit may set the virtual IP address as control information to an agent address section in a trap format of the SNMP version 3.

According to this configuration, it is possible to generate the trap message according to the version of the SNMP, and to transmit the generated trap message to the SNMP manager.

In a method according to the present invention, a computer may execute any one of the above-mentioned processings. That is, the present invention is a method of causing a computer to function as an SNMP proxy agent to relay management information from a monitored device to be managed by an SNMP manager. The method includes converting management information received from a monitored device which does not employ the SNMP as a management protocol into management information having a format compliant with the SNMP; converting specific information of the monitored device included in the management information into a virtual IP address indicative of the monitored device; generating an SNMP trap message in which the virtual IP address is set to a source address, and which includes the converted management information; and transmitting the generated SNMP trap message to an SNMP manager.

By providing the SNMP proxy agent between the monitored devices and the SNMP manager to relay the management information in this way, if the management information is transmitted from the monitored device managed by the SNMP manager to the SNMP manager, it is possible to supply the management information in an address format or data format easily managed by the SNMP manager as a trap to the SNMP manager.

According to the present invention, since the SNMP proxy agent converts the information used to identify the monitored device contained in the transmitted management information into the information in the virtual IP address format, the SNMP manager can always identify the information used to identify the monitored information in the IP address format, and the managing methods thus can be unified, resulting in simplified management and operation.

Moreover, according to the present invention, since it is not necessary for the SNMP manger to manage the local address of the monitored device, and even if there is added a non-SNMP device to be newly supported, there is not required a modification relating to the IP address management for the SNMP agents.

### BRIEF DESCRIPTION OF THE DRAWINGS

FIG. 1 is a block diagram showing a manger/agent model system according to an embodiment of the present invention;

FIG. 2 is a block diagram for illustrating a configuration and an operation of a proxy agent shown in FIG. 1;

FIG. 3 is a drawing showing a data structure of an IP conversion table;

FIG. 4 is a drawing showing a data structure of an IP frame;

FIG. 5 is a drawing showing a data structure of a trap according to the SNMPv1;

FIG. 6 is a drawing showing a data structure of a trap according to the SNMPv2 (v3);

FIG. 7 is a flowchart showing processing in an IP address conversion unit; and

FIG. 8 is a flowchart showing processing in a trap generation unit.

### DETAILED DESCRIPTION OF THE PREFERRED EMBODIMENT

A description will now be given of an embodiment of the present invention with reference to the drawings.

[Configuration of Manager/Agent Model System]

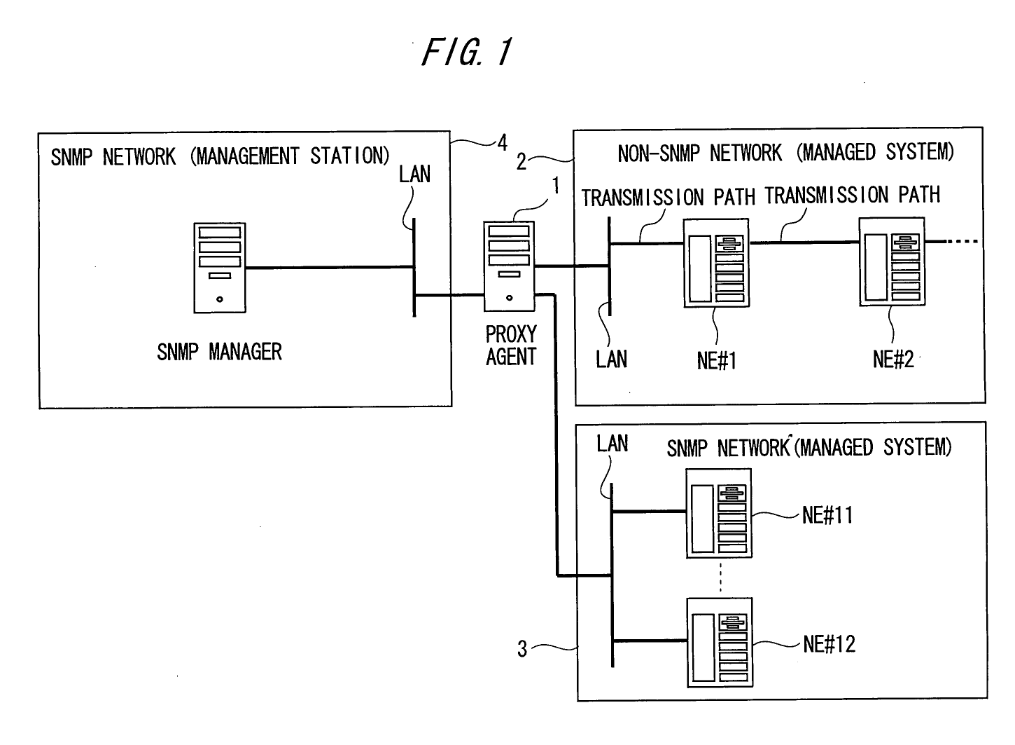

FIG. 1 is a block diagram showing a manger/agent model system according to an embodiment of the present invention.

Referring to FIG. 1 showing the embodiment of the present invention, the manger/agent model system having a manager/agent structure based upon the SNMP as a network management protocol is provided with a non-SNMP network 2 (managed system) including multiple monitored devices (NE#1, #2, . . . ) as network element devices which are SNMP incompliant agents, and transmission lines (paths) and a LAN (Local Area Network) which connect the monitored devices to a proxy agent 1 detailed later.

The manager/agent model system is provided with an SNMP network 3 (managed system) including multiple monitored devices (NE#11 to #12) as network element devices which are SNMP compliant agents and a LAN as an IP (Internet Protocol) network connecting these monitored devices to the proxy agent 1.

This manager/agent model system further includes an SNMP network 4 (management station) including an SNMP manager serving as a monitoring device which is connected to the proxy agent 1 via a LAN as an IP network. The SNMP manager monitors the managed systems, and collects management information such as failure information and status change information of the devices.

The respective monitored devices constructing the non-SNMP network 2 and the SNMP network 3, which are the managed systems, are specifically transmission devices and the like, and contain multiple terminal devices, not shown. Although the monitored devices on the non-SNMP network 2 are connected in a cascading connection form via the transmission lines, they may be connected in other connection forms such as ring type (loop shape) connection.

The respective monitored devices in the managed systems 2 and 3 use a trap which is a type of message compliant with the SNMP which is a protocol used to exchange management information used for network management, and operates upon the connectionless type protocol, UDP (User Datagram Protocol), in order to notify the SNMP manager in the management station 4 of the network failures, the status of the monitored devices, and the like via the proxy agent 1.

The trap is transmitted autonomously, and in one direction from the respective monitored devices in the managed systems 2 and 3 to the manager in the management station 4 via the proxy agent 1.

[Overview of System Configuration and Operation of Proxy Agent]

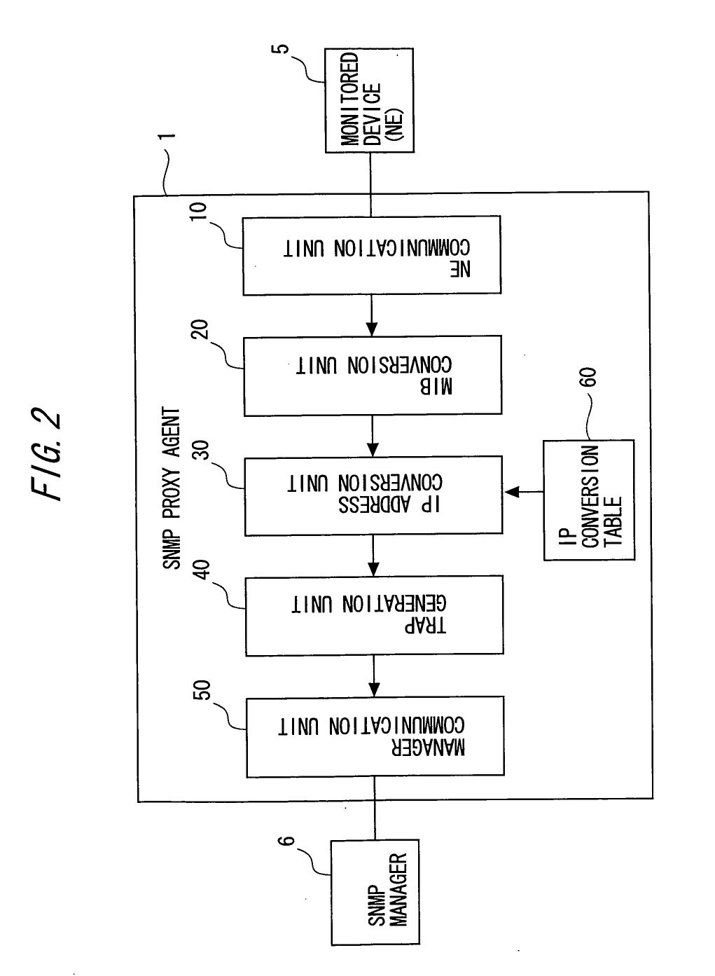

A description will now be given of a configuration and operation of the proxy agent 1 shown in FIG. 1 with reference to FIG. 2.

FIG. 2 is a block diagram showing an example of a system of the SNMP proxy agent 1. The SNMP proxy agent 1 is connected between the monitored device 5 (NE) to be managed in the system and the SNMP manager 6 which is the manager in the system. The SNMP proxy agent 1 is constructed by a computer such as a server machine, and is provided with a processor such as a CPU, a main storage device, an auxiliary storage device, a communication control device, an input device, and an output device, which are not shown, and further functions as a device including an NE communication unit 10, an MIB conversion unit 20, an IP address conversion unit 30, a trap generation unit 40, a manger communication unit 50, and an IP conversion table 60 as shown in FIG. 2.

A description will now be given of an overview of operations of the respective components functioning within the SNMP proxy agent 1. The NE communication unit 10 receives the management information (such as the failure information and status change information of the device) transmitted from the monitored device 5 (NE), and notifies the MIB conversion unit 20 of the received contents. The MIB conversion unit 20 receives the information notified from the NE communication unit 10, and converts the contents thereof into those in the MIB format, and notifies the IP address conversion unit 30 of the converted contents. The IP address conversion unit 30 converts an IP address (IP source address) of the sender (source of generation) included in the information notified from the MIB conversion unit 20 according to a condition, and notifies the trap generation unit 40 of the converted IP address as the IP address (IP source address) of the sender (source of generation). The sender IP address (IP source address) is obtained by referring to the IP conversion table 60. In other words, the address conversion unit 30 refers to the IP conversion table 60 in which respective pairs of a local address (NE No.: device number) which is information used to identify the monitored device and an IP address are registered, to convert the local address (NE No.: device number) which is information used to identify the monitored device into a virtual IP address.

The trap generation unit 40 generates a trap based upon the information notified from the IP address conversion unit 30, and notifies the manager communication unit 50 of the contents thereof. In other words, based upon the notified virtual IP address and management information (such as the failure information and status change information of the device), the trap generation unit 40 generates a trap whose sender is the virtual IP address. Note that, for a monitored device which uses the IP protocol on the lower layer of the management protocol, the trap generation unit 40 generates a trap whose sender is an actual IP address of the monitored device. The manager communication unit 50 transmits an IP frame containing the trap received from the trap generation unit 40 to the SNMP manager 6. On this occasion, the virtual IP address is set to the sender address of the IP header of the IP frame.

[Data Structure]

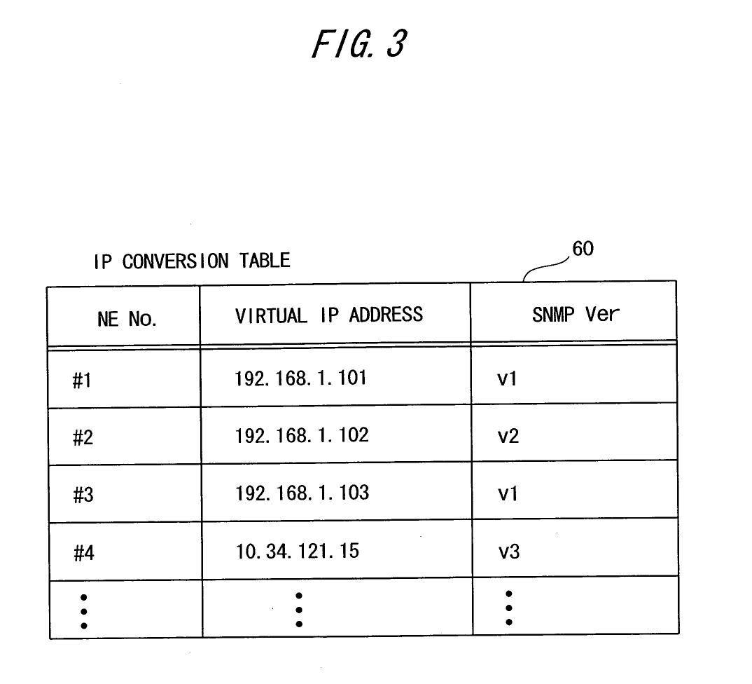

A description will now be given of data structures of respective data 60 to 90 with reference to FIG. 3 to FIG. 6.

<<IP Conversion Table>>

FIG. 3 shows an example of a data structure of the IP conversion table 60. On the IP conversion table 60, an “NE No.” represents the device number assigned to a monitored device to identify the monitored device. In this embodiment, the NE No. (device number) is treated as the local address. A “VIRTUAL IP ADDRESS” is a virtual IP address corresponding to each monitored device (NE No.). Note that if a monitored device is compliant with the SNMP, in a field indicating the virtual IP address is stored an actual IP address of the monitored device. An “SNMP Ver.” indicates version information of the SNMP corresponding to the respective monitored devices (NE Nos.).

<<IP Frame>>

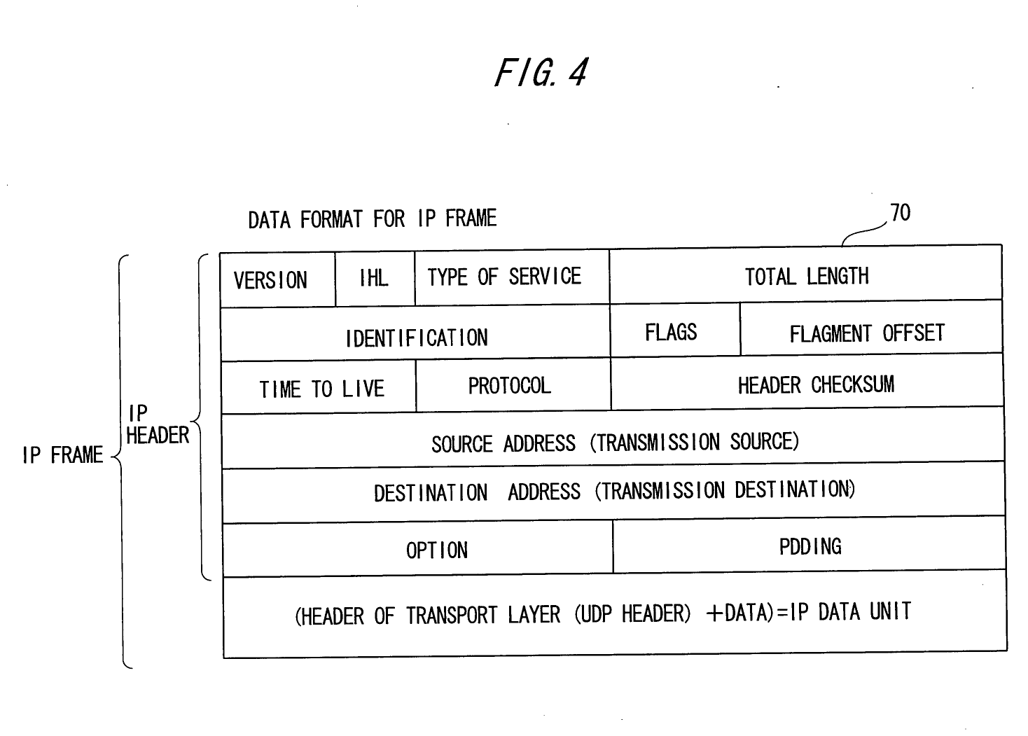

FIG. 4 shows an example of a data structure of the IP frame 70. The IP frame 70 is constructed by an IP header section containing control information such as identification information of data, and a priority of processing, and an IP data section containing a main body of data to be transmitted. Since the configuration of the IP header section is already known, a detailed description therefor is thus omitted, and only elements relating to the present embodiment will be described. As principle elements, the IP header section includes respective field sections indicating an address of a sender (SOURCE ADDRESS) and an address of a receiver (DESTINATION ADDRESS). The trap generation unit 40 sets the virtual IP address of the monitored device obtained by the IP address conversion unit 30 to the sender address section (SOURCE ADDRESS) of the IP header. Set to the receiver section (DESTINATION ADDRESS) of the IP header is an IP address of the SNMP manager 6. The IP data section has a structure in which a header on the transport layer (UDP header according to the present embodiment) is added to the main body of the transmitted data (management information such as the failure information and the status change information of the device).

<<Trap Data>>

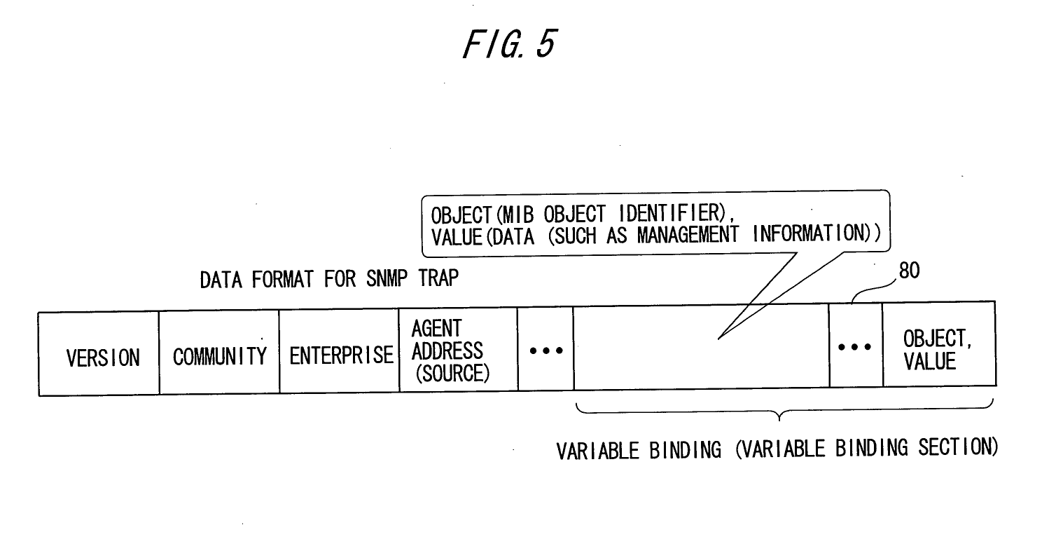

A description will now be given of a data structure of the trap, which is a PDU (Protocol Data Unit) generated in correspondence to the management information transmitted from the monitored device, and transmitted/received between the SNMP proxy agent 1 and the SNMP manager 6. The trap is used to notify the manager of the event (failure and status change of the device) generated on the agent. According to the present embodiment, the trap can be applied in the SNMPv1, v2, and v3, and a description will thus be given of the respective traps with reference to FIG. 5 to FIG. 7. Note that data structures of the respective traps are generally known, a detailed description is thus omitted, and a description will be given of only principle elements relating to the present invention.

FIG. 5 shows an example of the data structure of a trap 80 according to SNMPv1. The trap 80 is constructed of a header section containing control information and the like, and a data section (VARIABLE BINDING: variable binding section) containing data main body which is the management information. The header section includes a field section indicating a sender address (AGENT ADDRESS) as a principle element. The trap generation unit 40 sets the virtual IP address of the monitored device obtained by the IP address conversion unit 30 to the sender address section (AGENT ADDRESS) The data section includes respective fields to which a combination of an MIB object identifier and data is set. The trap 80 handles information as an object, and adds object identifiers to the respective filed sections to manage the information.

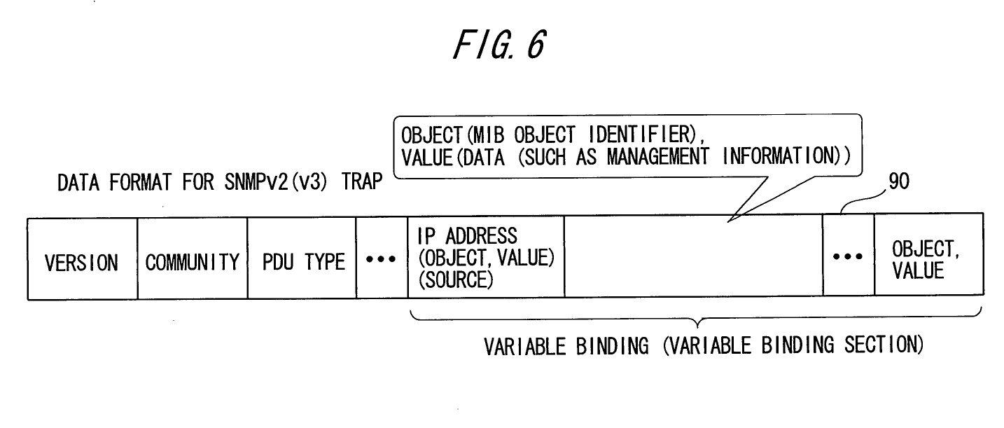

FIG. 6 shows an example of the data structure of a trap 90 according to SNMPv2 (v3). The trap 90 corresponds to the SNMPv2. The trap 90 is constructed of a header section containing control information and the like, and a data section (VARIABLE BINDING: variable binding section) containing data main body which is the management information. The structure of the header section does not closely relate to the present invention, and thus, a detailed description is thus omitted. The data section includes a field section indicating a sender address (IP ADDRESS) including a combination of an MIB object identifier and data. The trap generation unit 40 sets the virtual IP address of the monitored device obtained by the IP address conversion unit 30 to the sender section (IP ADDRESS) The trap 90 handles information as an object as the trap 80.

The data structure of the trap according to the SNMPv3 is the same as the data structure of the trap according to the SNMPv2 shown in FIG. 6, and a detailed description is thus omitted. The trap according to the SNMPv3 is applied if the version of the SNMP corresponding to the monitored device (NE No.) is v3.

[Operation Flow in IP Address Conversion Unit]

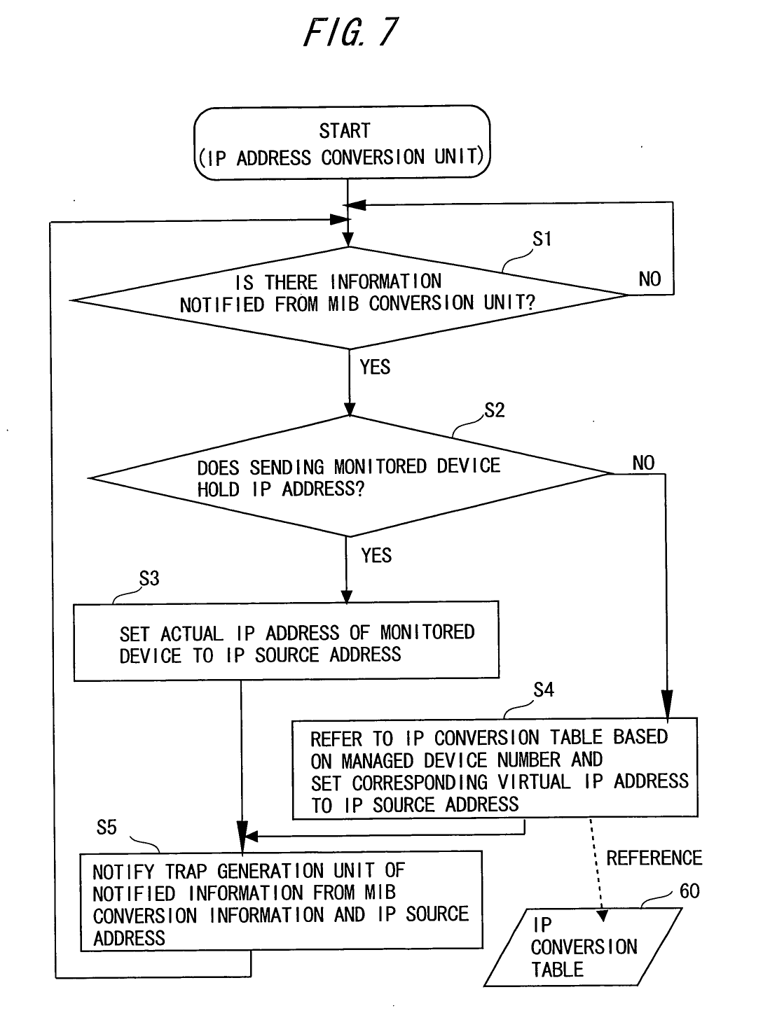

A description will now be given of specific processing carried out by the IP address conversion unit 30 within the SNMP proxy agent 1 with reference to FIG. 7.

FIG. 7 shows an example of an operation flow in the IP address conversion unit 30. In response to the management information notified from the MIB conversion unit 20, the IP address conversion unit 30 converts the local address included in the management information, which is used to identify the monitored device which is the sender, according to the condition, and notifies the trap generation unit 40 of the converted IP address as the IP address of the sender.

First, the IP address conversion unit 30 determines whether there is the information notified from the MIB conversion unit 20 (S1). If there is the information notified from the MIB conversion unit 20, the IP address conversion unit 30 determines whether a monitored device, which is the sender of the information, holds an IP address or not. (S2). If the monitored device in question is a device which does not holds an IP address according to the information notified from the MIB conversion unit 20, the IP address conversion unit 30 refers to the IP conversion table 60 which is set in advance as shown in FIG. 3, and sets a corresponding virtual IP address as a IP source address (S3). On the other hand, if the monitored device in question is a device which has an IP address, the IP address conversion unit 30 does not converts the IP address, and simply sets the actual IP address held by the monitored device to the IP source address (S4). The management information notified from the MIB conversion unit 20 and the obtained IP source address are notified to the trap generation unit 40 (S5). In this way, based upon the local address (NE No.: device number) which is the information used to identify the monitored device which is the sender of the transmitted management information (such as the failure information and the status change information of the device), the IP address conversion unit 30 obtains the virtual IP address corresponding to the local address from the IP conversion table 60, and notifies the trap generation unit 40 of the information including the obtained virtual IP address.

With this configuration, even if a monitored device does not have an IP address (even if a monitored device is not compliant with the SNMP), it is possible to convert specific information (such as a device name or a device number) used to identify the monitored device other than an IP address to a virtual IP address, thereby unifying the format of the address to the IP address format.

[Operation Flow in Trap Generation Unit]

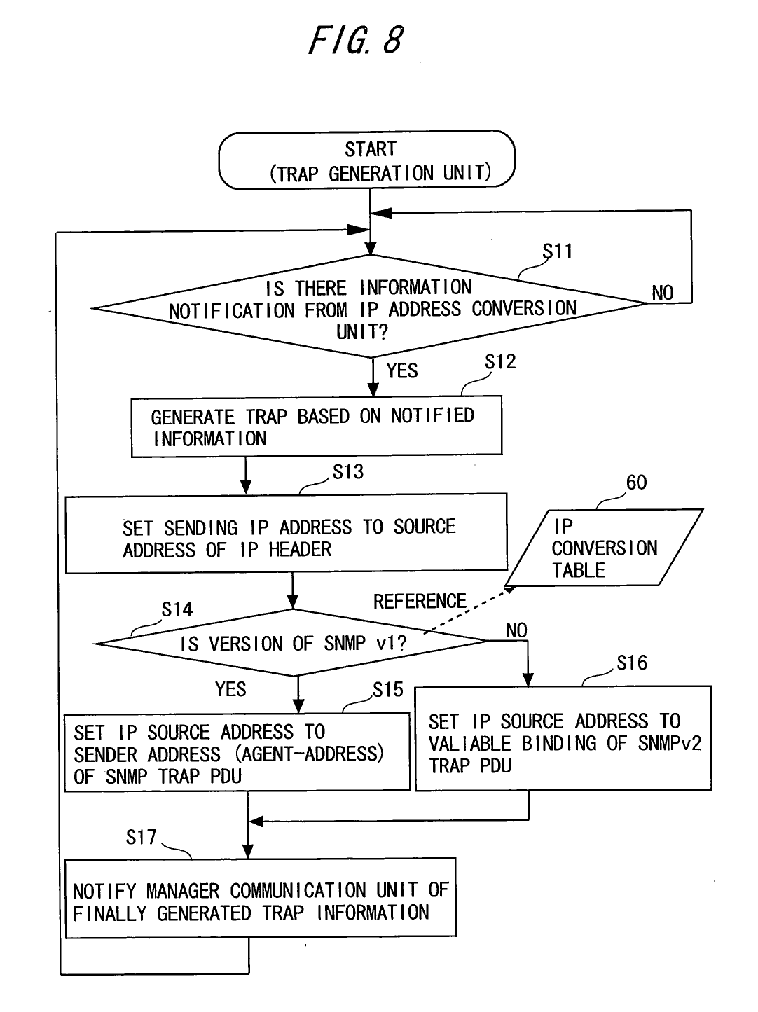

A description will now be given of specific processing carried out by the trap generation unit 40 within the SNMP proxy agent 1 with reference to FIG. 8.

FIG. 8 shows an example of an operation flow in the trap generation unit 40.

The trap generation unit 40 generates a trap based upon the management information and the IP source address notified from the IP address conversion unit 30, and notifies the manager communication unit 50 of the contents thereof.

The trap generation unit 40 first determines whether there is the information notified from the IP address conversion unit 30 to the trap generation unit 40 (S11) If there is the information notified from the IP address conversion unit 30, the trap generation unit 40 generates a trap (S12). The trap generation unit 40 then sets the IP source address notified from the IP address conversion unit 30 to the sender address section (SOURCE ADDRESS) of the IP header (S13).

Based upon the notified information, the trap generation unit 40 then makes the determination relating to the version information of the SNMP of the monitored device which is the sender of the management information (S14). The version information is contained in the information notified from the IP address conversion unit 30. If the corresponding version of the SNMP is v1 upon the determination of the version information of the SNMP, the trap generation unit 40 sets the IP source address notified from the IP address conversion unit 30 to the sender address section (AGENT ADDRESS) of the SNMP trap PDU (S15). On the other hand, if the corresponding version of the SNMP is v2 or v3, the trap generation unit 40 sets the IP source address received from the IP address conversion unit 30 to the variable binding section (VARIABLE BINDING) of the SNMPv2 (v3) trap PDU as an object (S16).

The trap generation unit 40 notifies the manager communication unit 50 of the finally completed trap information. Note that an address from a non-SNMP compliant monitored device is set to each trap PDU as a virtual IP address, it is thus not always necessary to set the IP source address to the sender address section (SOURCE ADDRESS) of the IP header section, and the setting may be carried out according to the management method of the SNMP manager.

As a result, even if a monitored device does not have an IP address (the monitored device is not compliant with the SNMP), it is possible to generate a trap where the format used to represent the sender of the management information from the monitored device is unified to the IP address.

[Specific Operation Example of Proxy Agent]

A description will now be given of a specific operation example of the SNMP proxy agent 1 with comprehensive reference to FIG. 1 to FIG. 8.

Specifically, the description will be given of a case where a state change occurs to a device No. “#2” on the SNMP incompliant network.

The NE communication unit 10 receives state change information as the management information including information on the device No. from the device “#2” on the SNMP incompliant network, and notifies the MIB conversion unit 11 of contents thereof.

The MIB conversion unit 11 receives the management information notified from the NE communication unit 10, and converts the management information into management information in the MIB format, and notifies the IP address conversion unit 30 of the converted management information. In other words, the MIB conversion unit 11 converts the management information transmitted from the monitored device into the management information in the format compliant with the SNMP.

Upon receiving the information converted into the MIB format from the MIB conversion unit 11, the IP address conversion unit 30 determines whether the monitored device, which is the sender of the information, holds an IP address or not. In this specific example, since the device No. “#2” is the monitored device which does not hold an IP address, the IP address conversion unit 30 refers to the IP address conversion table 60 set in advance shown in FIG. 3 to obtain a corresponding virtual address “192.168.1.102”. This virtual IP address is notified to the trap generation unit 40 as an IP source address of the management information. On the other hand, if a monitored device holds an IP address compliant with the SNMP, the IP address is not converted, and the actual address of the monitored device is notified as the IP source address to the trap generation unit 40.

The trap generation unit 40 sets the IP source address “192.168.1.102” notified from the IP address conversion unit 30 to the sender address section (SOURCE ADDRESS) in the IP header of the IP frame shown in FIG. 4. Moreover, the IP address conversion unit 30 notifies the trap generation unit 40 of SNMP version information obtained by the reference to the IP conversion table 60 shown in FIG. 3, and corresponding to the IP source address “192.168.1.102”. The trap generation unit 40 generates a trap using this version information. In this specific example, the version of the SNMP corresponding to the IP source address “192.168.1.102” is “v2”, an SNMPv2 trap shown in FIG. 6 is thus generated, and the IP source address “192.168.1.102” is set as an object to the variable binding section (VARIABLE BINDING) of the trap PDU. The trap generation unit 40 notifies the manager communication unit 50 of the trap generated in this way.

The manager communication unit 50 transmits the SNMPv2 trap, which is notified from the trap generation unit 40, and to which the virtual IP address “192.168.1.102” is set, to the SNMP manager 6.

In this way, according to the present invention, it is possible to uniformly manage all the management information notified from a monitored device not holding an IP address (monitored device not employing the SNMP as the management protocol), and all the management information notified from a monitored device holding an IP address (monitored device employing the SNMP as the management protocol) in the form of IP addresses.

The above embodiment is just an example. A specific configuration is not limited to that of the exemplified embodiment, and it is understood that design changes without departing from the sprit of the present invention are included within the scope of the present invention.

### INDUSTRIAL APPLICABILITY

The present invention can be applied to a system which uniformly manages monitored devices not using the SNMP as a management protocol and monitored devices using the SNMP as a management protocol on an SNMP manager.

[Others]

The disclosures of international application PCT/JP2003/001230 filed on Feb. 6, 2003 including the specification, drawings and abstract are incorporated herein by reference.

What is claimed is:

1. An SNMP (Simple Network Management Protocol) proxy agent, comprising:
a unit converting specific information of a monitored device which does not employ an SNMP as a management protocol into a virtual IP (Internet Protocol) address indicative of the monitored device; and
a unit generating an SNMP trap message in which the virtual IP address is set to a source address, and which is addressed to an SNMP manager.

2. An SNMP (Simple Network Management Protocol) proxy agent, comprising:
a format converting unit converting management information received from a monitored device which does not employ the SNMP as a management protocol into management information having a format according to the SNMP;
an IP (Internet Protocol) address converting unit converting specific information of the monitored device included in the management information into a virtual IP address indicative of the monitored device;
a trap generation unit generating an SNMP trap message in which the virtual IP address is set to a source address, and which includes the converted management information; and
a transmission unit transmitting the generated SNMP trap message to an SNMP manager.

3. The SNMP proxy agent according to claim 1, wherein if the trap generating unit receives management information from a monitored device employing the SNMP as a management protocol, the trap generating unit generates a trap message in which an IP address actually allocated to the monitored device is set to a source address.

4. The SNMP proxy agent according to claim 1, wherein if a version of the SNMP corresponding to the monitored device is a version 1, the trap generating unit sets the virtual IP address as control information to an agent address section in a trap format of the SNMP version 1.

5. The SNMP proxy agent according to claim 1, wherein if a version of the SNMP corresponding to the monitored device is a version 2, the trap generating unit sets the virtual IP address as control information to a data main body section in a trap format of the SNMP version 2 as an object.

6. The SNMP proxy agent according to claim 1, wherein if a version of the SNMP corresponding to the monitored device is a version 2, the trap generating unit sets the virtual IP address as control information to a data main body section in a trap format of the SNMP version 3 as an object.

7. A method of relaying management information from a monitored device to be managed by an SNMP (Simple Network Management Protocol) manager, the method being executed by an SNMP proxy agent and comprising:
converting management information received from a monitored device which does not employ an SNMP as a management protocol into management information having a format according to the SNMP;
converting specific information of the monitored device included in the management information into a virtual IP address indicative of the monitored device;
generating an SNMP trap message in which the virtual IP address is set to a source address, and which includes the converted management information; and
transmitting the generated SNMP trap message to the SNMP manager.
